(19) United States
(12) Patent Application Publication
(10) Pub. No.: US 2014/0238247 A1
(43) Pub. Date: Aug. 28, 2014

(54) FLOW DISPENSER, FLAVOR ADAPTER, AND FLAVOR PACK

(71) Applicant: apiqe inc, Torrance, CA (US)

(72) Inventors: Erdogan Ergican, Torrance, CA (US); Giancarlo Fantappie, Rancho Palos Verdes, CA (US); Sann Myint Naing, Monterey Park, CA (US)

(73) Assignee: apiqe inc, Torrance, CA (US)

(21) Appl. No.: 14/138,817

(22) Filed: Dec. 23, 2013

Related U.S. Application Data
(63) Continuation of application No. PCT/US2012/043873, filed on Jun. 22, 2012.
(60) Provisional application No. 61/500,500, filed on Jun. 23, 2011.
(60) Provisional application No. 61/500,440, filed on Jun. 23, 2011.

(51) Int. Cl. A47J 31/00

(52) U.S. Cl. CPC B67D 1/0021
USPC 99/289 R

(57) ABSTRACT

In one aspect, an apparatus is disclosed for dispensing water including: a first inlet, a second inlet, and a third inlet; a chamber in fluid communication with first, second and third inlets, and a dispenser nozzle in fluid communication with the chamber.

### CROSS-REFERENCE TO RELATED APPLICATIONS

This application claims the benefit of U.S. Provisional Patent Application. Ser. Nos. 61/500440 and 61/500500, each filed Jun. 23, 2011, the entire contents of each of Which are in are incorporated by reference herein.

This application is also related to U.S. Provisional Application Nos. 61/500451, 61/500469, 61/500500, 61/500440, 61/500461, each filed Jun. 23, 2011, and U.S. Provisional Application No. 61/654487, filed Jun. 1, 2012. The entire contents of each of the foregoing applications are incorporated by reference herein.

### BACKGROUND

Numerous types of water dispensers are available, including dispensers for chilled, unchilled (e.g., room temperature), and heated water. Some water dispensers dispense carbonated water. Water dispensers can include a reservoir or a pressurized source. Water dispensers may be stand alone devices, or incorporated into an appliance such as a refrigerator.

Most commercialized devices for carbonating water use carbon dioxide sprayed into a water container: the result obtained with this process is very poor and the carbonation of water is weak and does not last too long. Devices for producing and dispensing carbonated beverages in water dispensing units, instead, typically employ a carbonating tank, called a saturator, and a high-pressure water pump. Carbonated water is produced by pressurizing the saturator tank with carbon dioxide and filling the tank with chilled water. Due to the high pressures resident in the saturator tank, typically around 70 psi, a relatively expensive high pressure water pump is required to inject water into the tank. Furthermore, under the conditions in the saturator tank, the carbon dioxide takes time to dissolve into to the water and achieve a palatable level of carbonization. Accordingly, the saturator is typically large enough to hold a ready supply of carbonated water for dispensing and does not create new carbonated water instantaneously on demand. To maintain this supply, two or more sensors-and associated electronic controls—are used to start the high pressure pump and inject water into saturator when the level of carbonated water in the saturator falls below a set threshold and then stop the water injection when the tank fills to an appropriate level.

These typical carbonization devices take up a relatively large amount of space and require expensive and complicated electronic and hydraulic control systems. Due to this complex structure, these devices are noisy, use significant amounts of energy, and require frequent maintenance.

Flavored beverages may be made by mixing water with a flavoring material (referred to herein as generally as “flavor” or “flavor content”). Flavor content may take a number of forms including liquid (e.g., a syrup), soluble or insoluble solids (e.g., powders, tea leaves, coffee grounds, etc.). Flavored beverages include cold beverages (e.g., flavored soda, fruit flavored drinks, etc.) or hot beverages (e.g., coffee, tea, hot cocoa).

Today's on-the-go consumers increasingly expect to have access to flavored beverages with a large number of flavor options provided in a convenient, clean, easy to use form. For example, convenience stores typically stock dozens of types beverages, including flavored waters, carbonated sodas, coffee, tea, etc. These beverage are available in a variety of sizes and containers.

### SUMMARY

The applicants have realized that a flow dispenser of the type described herein may be provided to condition the dispensed flow of water from a water dispensing system, e.g., a water dispensing system featuring an in line carbonator.

In one aspect, an apparatus is disclosed for dispensing water including: a first inlet, a second inlet, and a third inlet; a chamber in fluid communication with first, second and third inlets, and a dispenser nozzle in fluid communication with the chamber.

In some embodiments, the chamber is tapered with a wide end proximal the first, second, and third inlets and a narrow end proximal the nozzle.

In some embodiments, the chamber operates as an expansion chamber for water flowing from any one of the inlets into the chamber.

In some embodiments, at least one of the first, second, and third inlets includes a check valve configured to allow forward flow in a forward flow direction from the inlet to the chamber and to reduce or prevent back flow from the chamber in the opposite of the forward flow direction.

In some embodiments, the chamber includes at least one exhaust port configured to allow vapor or gas to exhaust from the chamber.

In some embodiments, the nozzle includes a converging nozzle.

In some embodiments, the nozzle includes at least one connection facility for connecting a peripheral device.

In some embodiments, the connection facility includes a twist and lock connector.

In some embodiments, the connection facility includes at least one O-ring seal.

Some embodiments include a UV light source positioned to direct UV light onto water flowing into, through, or out of the apparatus. In some embodiments, the UV light source directs UV light onto water with a dosage of at least 1,000, at least 10,000, at least 100,000 or at least 500,000 microwatt seconds per square centimeter.

In some embodiments, the chamber is configured to: receive a carbonated water flow through at least one of the inlet; condition the flow to reduce a flow rate or spattering of the carbonated water flow; and direct a conditioned flow out through the nozzle.

In some embodiments, the conditioned flow directed out through the nozzle is more laminar than the carbonated water flow received through the inlet.

In another aspect, a method is disclosed including, using a apparatus of any of the types described above: receiving a carbonated water flow through at least one of the inlet; conditioning the flow to reduce a flow rate or spattering of the carbonated water flow; and directing a conditioned flow out through the nozzle.

Some embodiments include: expanding the flow of carbonated water as the water moves from the inlet into the chamber.

In some embodiments, the conditioned flow directed out through the nozzle is more laminar than the carbonated water flow received through the inlet.

Some embodiments include directing UV light onto water flowing into, through, or out of the apparatus, e.g., with a dosage of at least 1,000, at least 10,000, at least 100,000, or at least 500,000 microwatt seconds per square centimeter.

In another aspect, a system including: an apparatus of any of the types described above; a chilled carbonated water source in fluid communication with the first inlet; an unchilled water source in fluid communication with the second inlet; and a heated water source in fluid communication with the third inlet.

In some embodiments, the chilled carbonated water source is configured to selectively dispense carbonated and still water.

In some embodiments, the chilled carbonated water source includes an in-line carbonator.

The applicants have realized that it would be advantageous to provide flavored beverages using water from a water dispenser. The devices and techniques described herein allow for the production of flavored beverage using dispensed water. A flavor adapter easily attaches to a dispenser of any suitable type. The adapter receives a flavor pack containing flavor, and facilitates mixing of the flavor with the dispensed water to produce a flavored beverage. The adapter and pack allow flavored beverages to be produced with a variety of flavors, in convenient quantities (e.g., single serving), without messiness, etc.

In one aspect, a flavor adaptor is disclosed including: a water inlet configured for attachment to a water dispenser; a housing which receives a flavor pack containing flavor content; a flavored beverage outlet; where the adaptor is configured to direct a flow of water from the inlet, through the flavor packet to mix with the flavor content, and out through flavored beverage outlet.

In another aspect, a flavor pack is disclosed including: a sealed interior containing flavor content; a sealed water inlet; a sealed flavored beverage outlet; where the sealed water inlet and the sealed flavored beverage outlet are configured to be unsealed to allow a flow of water from the inlet, through the interior of the flavor packet to mix with the flavor content, and out through flavored beverage outlet.

In another aspect, a method of producing a flavored beverage is disclose, the method including: attaching the water inlet of the flavor adaptor described above to a water dispenser; inserting the flavor pack described above into the adaptor; using the flavor adaptor to unseal sealed water inlet and the sealed flavored beverage outlet of the flavor pack; establishing a flow of water from the dispenser, through the inlets, through the interior of the flavor packet to mix with the flavor content, and out through flavored beverage outlets.

Various embodiments may include any of the above described elements, alone or in any suitable combination.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The accompanying drawings, which are incorporated in and constitute a part of this specification, illustrate one or more embodiments described herein and, together with the description, explain these embodiments. Like reference characters refer to the same parts throughout the different views. The drawings are not necessarily to scale, emphasis instead being placed upon illustrating the principles of the embodiments.

FIG. 1 is a functional block diagram of a water dispenser.

FIGS. 2A-2I show views of a flow dispenser. FIG. 2A shows a top down perspective exploded view. FIG. 2B shows a bottom up perspective exploded view. FIG. 2C is a top down view. FIG. 2D is a side elevation view. FIG. 2E is a front elevation view. FIG. 2F is a cross section through AA as identified in FIG. 2C. FIG. 2G is a cross section through BB as identified in FIG. 2C. FIG. 2H is a cross section through CC as identified in FIG. 2C. FIG. 2I is a cross section through DD as identified in FIG. 2C. Note that although exemplary dimensions are shown, in various embodiments other dimensions may be used.

FIG. 3 shows a perspective view of an open flavor adaptor receiving a flavor pack.

FIG. 4A is a top down view of assembled flavor adaptor enclosing a flavor pack. Internal componets of the adaptor are indicated with light dashed lines. The flavor pack is indicated with dark dashed lines.

FIG. 4B is a cross section of the assembled flavor adaptor enclosing the flavor pack of FIG. 3A along AA.

FIG. 4C is a side view the assembled flavor adaptor enclosing the flavor pack of FIG. 3A. Internal componets of the adaptor are indicated with light dashed lines. The flavor pack is indicated with dark dashed lines.

FIG. 5A shows a perspective top view of the flavor pack.

FIG. 5B shows a perspective bottom view of the flavor pack.

FIG. 5C shows a perspective bottom view of the flavor pack with a bottom sealing film removed and showing flow lines illustrating the flow of water through the pack.

### DETAILED DESCRIPTION

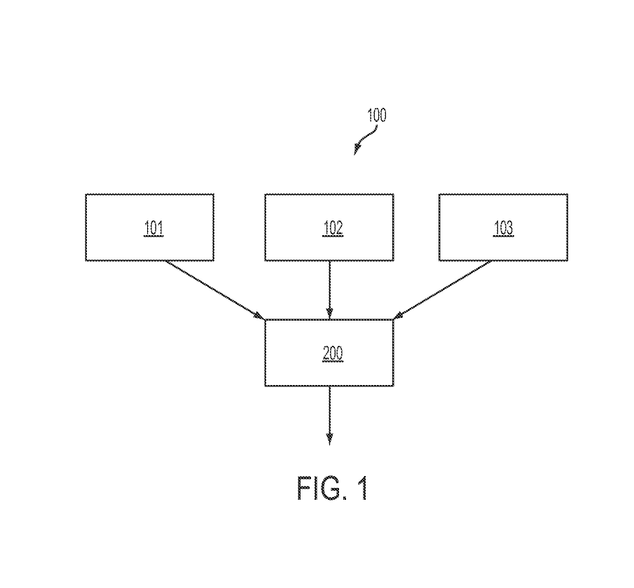

FIG. 1 shows a functional block diagram of a system 100 for dispensing water. The system 100 includes three water sources 101, 102, and 103 (although any other number may be used) that deliver water to a single flow dispenser 200 for dispensing. For example, in some embodiments, the system 100 is of the type described in Application No. 61/600,451 incorporated by reference above.

As shown, the sources include a chilled carbonated water source 101. Carbonated water source 101 may include an in-line carbonator, e.g., of the type described in U.S. patent application Ser. No. 12/772,641 filed May 3, 2010 entitled “APPARATUSES, SYSTEMS AND METHODS FOR EFFICIENT SOLUBILIZATION OF CARBON DIOXIDE IN WATER USING HIGH ENERGY IMPACT,” the entire contents of which are incorporated herein by reference. This reference describes an apparatus that can be placed in a water line path to create carbonated water for dispensing. The apparatus accepts carbon dioxide and water through an inlet path. From there the flow of carbon dioxide and water are passed through one or more dispersion elements arranged within the conduit to create a dispersed flow (e.g., an annular dispersed flow). The dispersed flow then passes through a passive accelerator within the conduit, thereby greatly increasing the kinetic energy of the system. The accelerated flow is directed to collide with a rigid impact surface immediately downstream of the passive accelerator. This collision creates sufficient pressure to solubilize the carbon dioxide into the water. A retention network is provided at the output of the apparatus to collect and regulate the flow of carbonated water.

In other embodiments, the carbonator may include other (non-“in line”) carbonator types. For example, some carbonators use carbon dioxide sprayed into a water container. Other carbonators employ a carbonating tank, called a saturator, and a high-pressure water pump. Carbonated water is produced by pressurizing the saturator tank with carbon dioxide and filling the tank with chilled water. Due to the high pressures resident in the saturator tank, typically around 70 psi, a relatively expensive high pressure water pump may be required to inject water into the tank. Furthermore, under the conditions in the saturator tank, the carbon dioxide takes time to dissolve into to the water and achieve a palatable level of carbonization. Accordingly, the saturator is typically large enough to hold a ready supply of carbonated water for dispensing and does not create new carbonated water instantaneously on demand. To maintain this supply, two or more sensors—and associated electronic controls—are typically used to start the high pressure pump and inject water into saturator when the level of carbonated water in the saturator falls below a set threshold and then stop the water injection when the tank fills to an appropriate level.

In some embodiments, the carbonated water source 101 may selectively dispensed chilled carbonated water or chilled non-carbonated (“still”) water, e.g., by selective delivery of carbonating gas to an inline carbonator, as described in detail in Application No. 61/600,451 incorporated by reference above.

In some embodiments, the water source 102 may be an unchilled water source. In some embodiments, the water source 103 may be a heated water source.

In various applications, one or more of the water sources 101, 102, and 103 may output water flows with certain unwanted characteristics including, e.g., an overly high flow rate, unwanted turbulence, spattering, etc. The flow dispenser 200 receives the flows from the water sources 101, 102, and 103, and conditions the flow to eliminate or reduce one or more unwanted characteristics. For example, the flow dispenser 200 may condition the flow to have a different (e.g. lower) flow rate, less turbulence (e.g., corresponding to a more laminar flow), less spattering., etc.

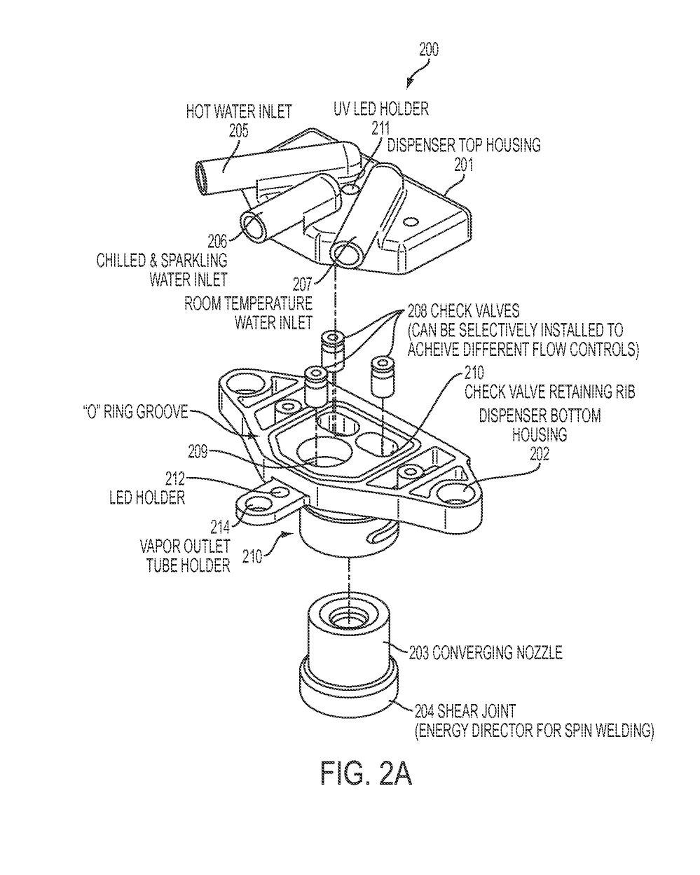

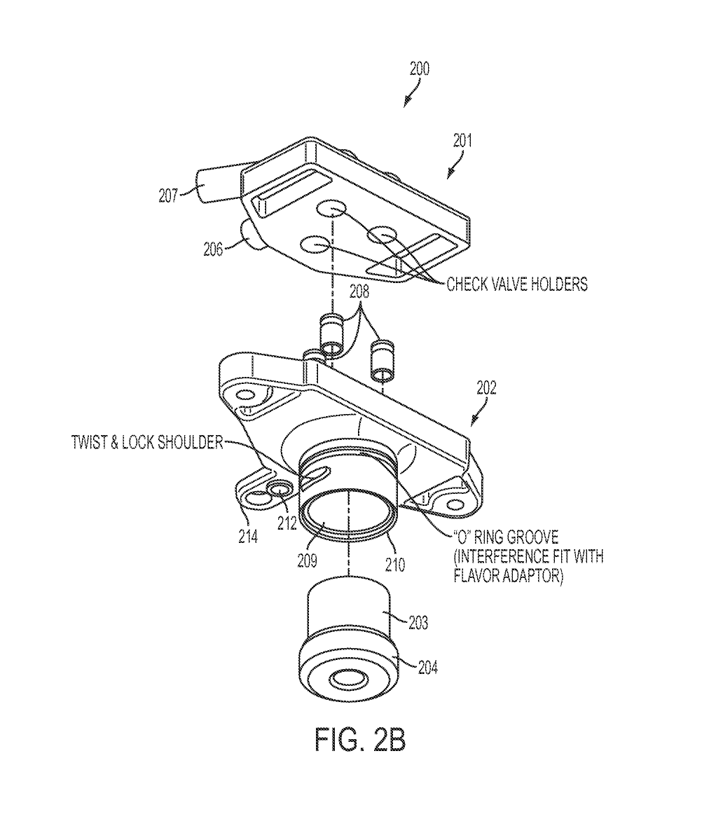

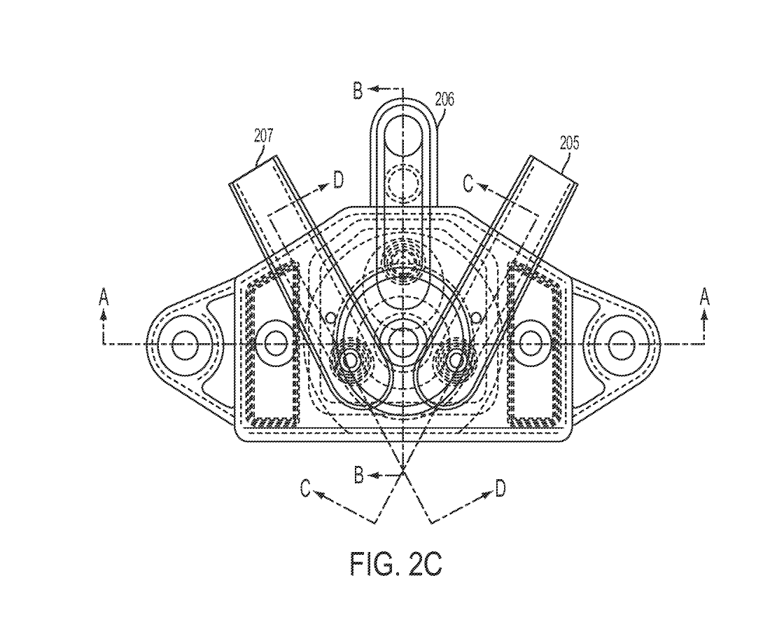

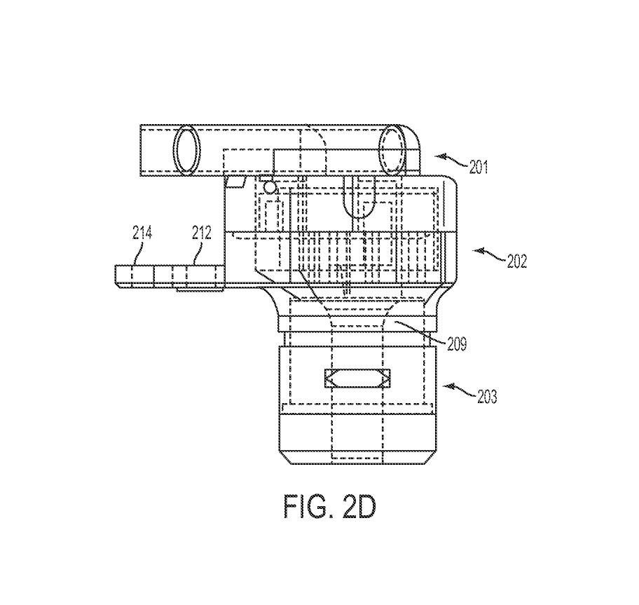

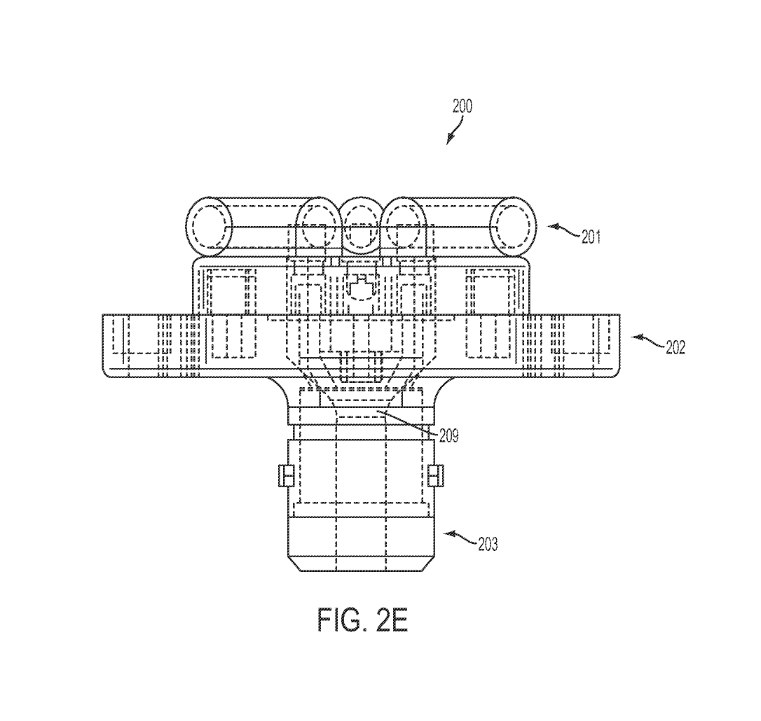

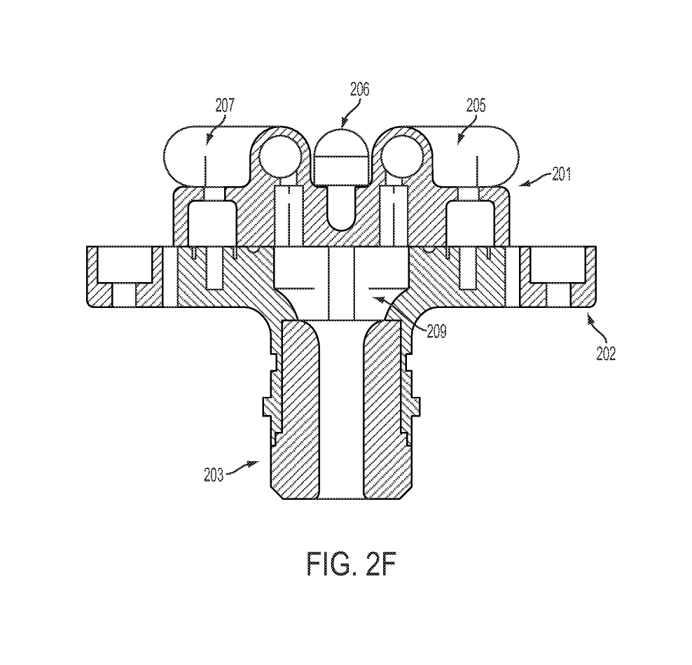

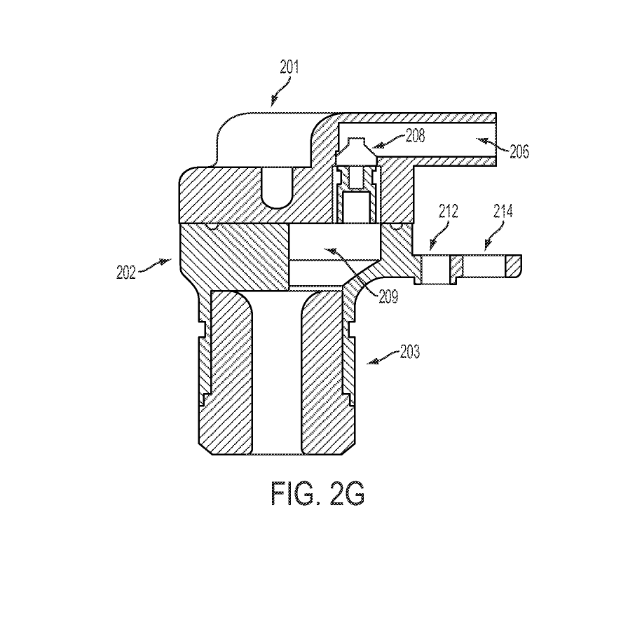

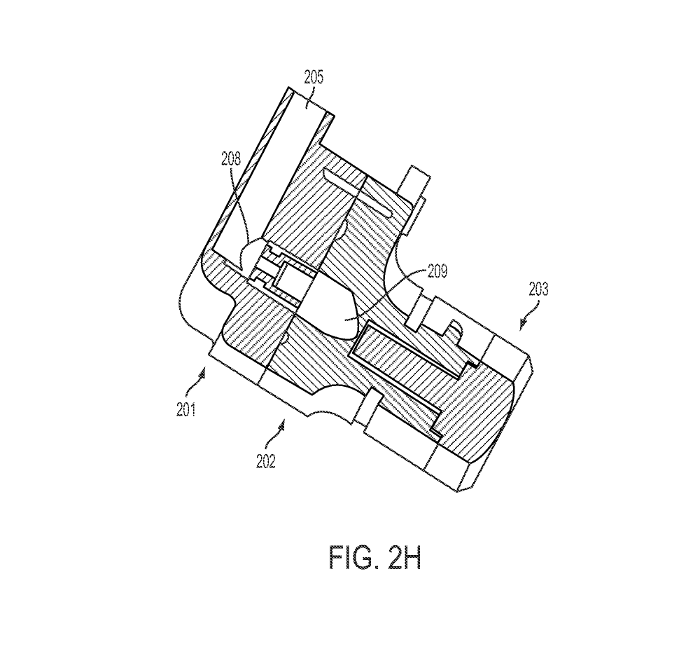

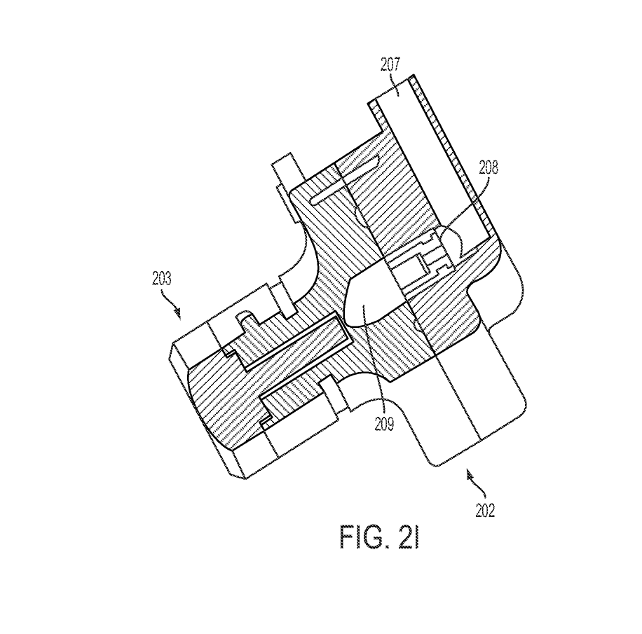

FIGS. 2A-2I show views of an embodiment of flow dispenser 200. The flow dispenser 200 is made up of three main components, an upper housing 201, a lower housing 202, and a nozzle 203. In other embodiments, the dispenser 200 may be made of more or fewer components. The components may be assembled using any know technique to provide a watertight fit. For example, bolts or other fasteners may pass through holes in the upper housing 201 into the lower housing 202 to secure the components together. The nozzle 203 may be welded to the lower housing 202, e.g., using spin welding techniques known in the art. The nozzle 203 may include one or more energy directing features such as a shear joint 204 to facilitate welding. In various embodiments, other assembly techniques may be used including gluing, mechanical attachment, etc.

The upper housing includes three inlets, a hot water inlet 205 (for connection to the hot water source 103), a chilled water inlet 206 (for connection to selective chilled carbonated/still water source 101), and an unchilled water inlet 207 (for connection to the unchilled water source 102). In some embodiments, the dispenser 200 includes fewer or additional inlets, e.g., a fourth inlet (not shown) to allow flavor content (e.g., a flavored syrup) to be delivered and mixed with the water flow through the dispenser 200.

Water received by each inlet passes through a respective check valve 208 into an interior chamber 209 of the dispenser 200. As shown, each of the inlets 205, 206, 207 feature an L-shaped bend. However, in various embodiments, any other bend angle, multiple bends, no bends, or any other suitable shape may be used.

The check valves may be mounted between check valve holders formed in the upper housing 201 and check valve retaining ribs 210 in the lower housing 202. In other embodiments, the valves may be secured using any other suitable attachment. In some embodiments, the check valve 208 for each inlet be identical or different (e.g., to provide differential flow control). In some embodiments, one or more of the check valves 208 may be omitted. In some embodiments, other types of valves may be used, including, for example controllable (e.g., solenoid) valves which can be controlled by a controller to interrupt or regulate the flow through each inlet. In some embodiments, a check valve similar to 208 is used in the converging nozzle 203.

The chamber 209 acts as expansion chamber, such that the flow from the inlets 205, 206, 207 experiences an increased cross sectional area at the transition from the inlets to the chamber. This may advantageously condition the flow, e.g., by reducing pressure, flow rate, spattering, turbulence, etc. For example, in some embodiments, a high pressure, turbulent, non-constant (spattering) flow of carbonated water enters through inlet 206. The flow expands and strikes the interior walls of the chamber. The pressure and flow rate is reduced. Water from the chamber drains out through the nozzle with a desired flow rate, reduced pressure, reduced spatter, and more laminar flow.

In some embodiments, the chamber 209 has a tapered shape with a wider portion near the inlets 205, 206, and 207 and a narrow portion near the nozzle 203. In some embodiments, the chamber 209 may include one or more vapor exhaust ports to allow gas or vapor displaced by the inflow of water to exit the chamber.

As shown, the nozzle 203 may be a converging nozzle. In various embodiments, the convergence of the nozzle may be fixed (as shown) or adjustable. In other embodiments the nozzle may be of any other suitable type, e.g., diverging, converging-diverging, etc. The nozzle 204 may contain one or more valves (e.g. a check valve, a shut off valve, or a control valve) or one or more filters.

In some embodiments, the dispenser 200 includes a holder 211 for the UV light which directs light onto the water entering, flowing through, or exiting the dispenser. The UV light operates to disinfect or otherwise clean the water. When ultraviolet energy is absorbed by the reproductive mechanisms of bacteria and viruses in the water, the genetic material or the organisms' DNA/RNA is rearranged and they can no longer reproduce, reducing or eliminating the risk of disease. UV-rays are energy-rich electromagnetic rays that are found in the natural spectrum of the sunlight. They are in the range of the invisible short wave light having a wavelength ranging from 100 to 400 nm. The UV light may provide UV doses in the range of, e.g., 1000-500,000 microwatt seconds per square centimeter, or any suitable subrange thereof. Such doses have been recognized as effective for reducing or eliminating water born contaminates.

In some embodiments, the flow dispenser 200 includes a facility 210 (as shown a twist and lock connector with an O-ring groove) which allows for attachment of one or more peripheral devices. The peripheral device may include a device for mixing flavor content with the dispensed water stream, e.g., as described in Application No. 61/500,500 incorporated by reference above. In other embodiments, the peripheral device may be a container to be filled with the dispensed water.

The flow dispenser 200 may include a visible light source holder 212 which holds a light source (e.g., an LED which outputs visible light) to illuminate the region below the nozzle 203.

The flow dispenser 200 may include a vapor outlet tube holder 214, which holds a vapor (or other gas) outlet tube from one or more components of the system 100. For example, the hot water source 103 may include a hot water tank, and the outlet tube may be used to exhaust steam from the tank.

The flow dispenser may be made of any suitable material. In some embodiments, one or more of the upper and lower housings and nozzle are formed from or include a plastic (e.g., a thermoplastic) or polymer material (e.g., ABS, PP, PE, Acetal, PFTE, PV, PU, nylon, etc.), a metal (e.g., copper, bronze, iron, steel, stainless steel, etc.), a composite, etc. The components may be fabricated using any suitable technique including, e.g., molding (e.g., injection molding), machining (e.g., using one or more computer numerical controlled “CNC” tools such as a mill or lathe), etc.

Any suitable connection may be used to attach the flow dispenser 200 to the water sources 101, 102, and 103. The connection may be permanent (e.g., glued) or detachable (e.g., using threaded connections). Any threaded connections may be national pipe thread tapered thread (NPT) or national pipe thread tapered thread fuel (NPTF) standard connections. In some embodiments, the threaded connections provide leak proof fittings mechanically, without the need for Teflon thread tape or similar applications.

The examples described above are presented with reference to providing a flow dispenser for a flow of carbonated water. However, as will be understood by one skilled in the art, the devices and techniques described herein may be applied to provide flow dispensing for any suitable fluid flow, including any suitable mixed flow of liquid and gas.

### Flavor Adapter and Flavor Pack

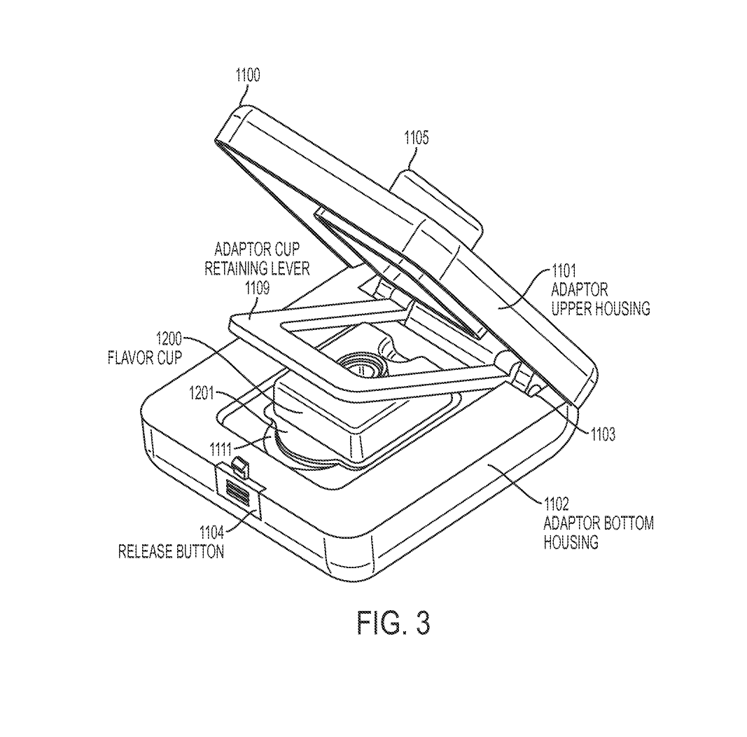

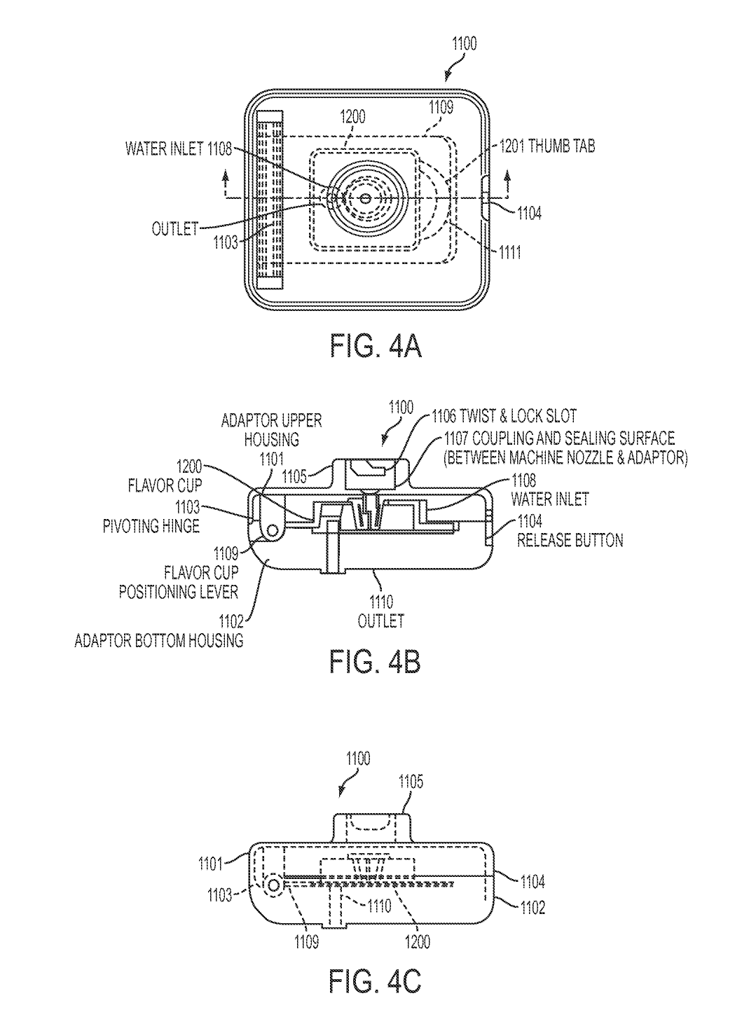

FIGS. 3 and 4A-4C illustrate a flavor adaptor 1100 which receives a flavor pack 1200. The flavor adaptor 1100 includes an upper housing 1101 and a lower housing 1102 attached with a hinge 1103, e.g., a pivot hinge. The hinge 1103 may be of any suitable type, including a spring loaded hinge. In some embodiments, the hinge opens and remains in a fully opened position, but snaps shut to a closed position when the upper housing 1101 is moved towards the lower housing 1102 past a threshold position.

The adaptor 1100 also includes a release button 1104 which locks and unlocks the upper and lower housings 1101, 1102 together. The release button 1104 may use any type of locking mechanism known the art, including a spring latch, cam lock, etc. The locking mechanism may be mechanical, hydraulic, magnetic, electrical, or any other type.

The upper housing 1101 includes a connector 1105 for connecting the adaptor 1100 to a water dispenser outlet. As shown, the connector 1105 is a twist and lock connector which includes a twist and lock slot 1106 and a coupling and sealing surface 1107 which provides a water tight connection with the dispenser. However, in other embodiments, any other suitable connector type may be used, including, e.g., a threaded connector such as national pipe thread tapered thread (NPT) or national pipe thread tapered thread fuel (NPTF) standard connection, In some embodiments, the threaded connections provide leak proof fittings mechanically, without the need for Teflon thread tape or similar applications.

The upper housing provides an inlet 1108 which directs a flow of water from the dispenser through the upper housing 1101 to the flavor pack 1200. In some embodiments, the inlet 1108 may include one or more piercing members which, when the adaptor 1100 is closed with flavor pack 1200 in place, pierce through a seal on the flavor pack 1200 to allow water flow from the inlet 1108 into the interior of the flavor pack. The piercing member may include one or more sharp edges or pointed features.

The lower housing 1102 receives the flavor pack 1200 and includes a flavor cup positioning lever 109 to properly align the pack 1200 prior to closing the adaptor 1100. The positioning lever 1109 (also referred to as a retaining lever) may be spring loaded, and may clamp down on one or more tabs or other features on the flavor pack 1200 to retain the pack in place. In some embodiments, the lever 1109 may share a common pivot hinge with the upper and lower housings 1101, 1102. In other embodiments, any other suitable positioning or alignment device may be used, including mechanical devices (e.g., latches, locks, tabs/slots), hydraulic devices, pneumatic devices (e.g., using vacuum or positive pressure to retain the pack), magnetic devices, etc.

The lower housing 1102 includes an outlet 1110 that allows water to flow from an outlet of the flavor pack 1200. In some embodiments, the outlet 1110 may include one or more piercing members that, when the adaptor 1100 is closed with flavor pack 1200 in place, pierces through a seal on the flavor pack 1200 to allow water mixed with flavor to flow from the interior of the flavor pack out through the outlet 1110. The piercing member may include one or more sharp edges or pointed features.

As shown the water inlet 1108 is aligned with the center of the flavor pack while the outlet 1110 is positioned off center. However, in various embodiments this configuration may be reversed, or any other suitable configuration may be used.

The lower housing 1102 includes a recess 1111 which receives a thumb tab 1201 on the flavor pack 1200 for removal of the pack after use. In various embodiments, the adaptor 1100 may include any other suitable mechanism or facility for removal or ejection of the spent flavor pack 1200 including, e.g., mechanical devices (e.g., levers, tabs, springs, etc.), hydraulic devices, pneumatic devices (e.g., using vacuum or positive pressure to eject the pack), magnetic devices, etc.

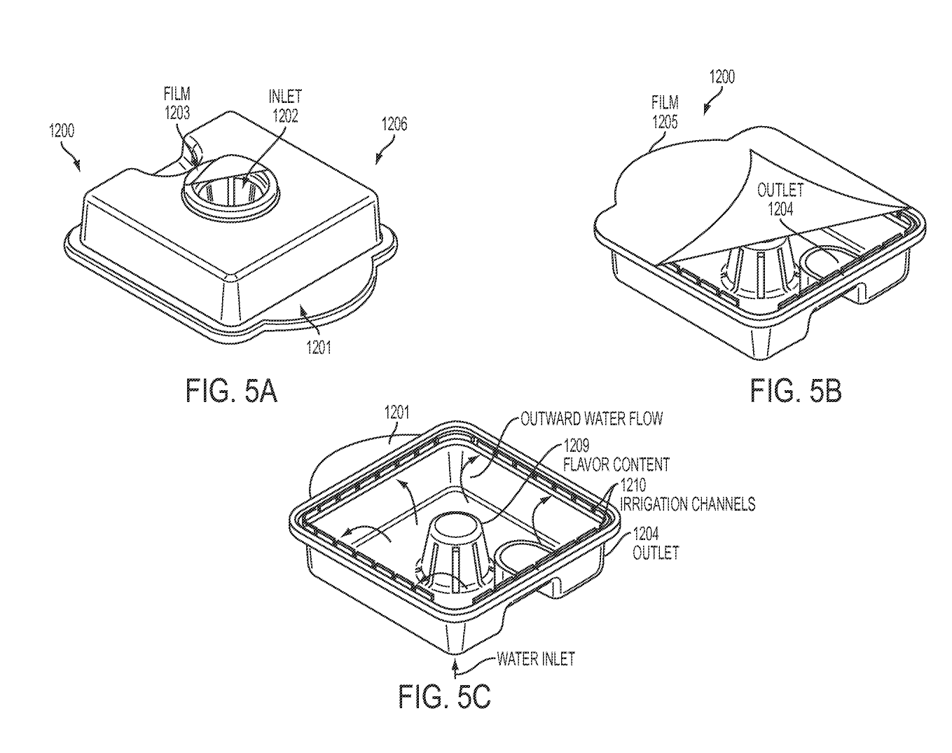

FIGS. 5A-5C show an exemplary embodiment of flavor pack 1200. FIG. 5A shows the top side of the pack 1200 (e.g., the side designed to face the upper housing 1101 of the adaptor 1100). The top side includes a pack inlet 1202 sealed with a inlet film 1203. As shown, the film 1203 is peeled back for illustrative purposes only. In practice, the inlet 1202 is sealed with the inlet film 1203 which remains in place until the adaptor 1100 closes around the pack 1200, at which time the inlet 1108 of the adaptor 1100 pierces the film 1203 allowing water flow into the interior of the pack 1200.

The inlet 1100 may include any suitable features used to control or direct the flow of water. As shown, the inlet includes a capped tapered section having slots which tend to direct the inlet water from the central portion of the pack 1200 towards the periphery of the pack 1200 (see FIG. 4C).

FIG. 5B shows the bottom side of the pack 1200 (e.g., the side designed to face the lower housing 1102 of the adaptor 1100). The bottom side includes a pack outlet 1204 sealed with a outlet film 1205. As shown, the film 1205 is peeled back for illustrative purposes only. In practice, the outlet 1204 is sealed with the inlet film 1203 which remains in place until the adaptor 100 closes around the pack 1200, at which time the outlet 1110 of the adaptor 1100 pierces the film 1205 allowing water mixed with flavor flow out from the interior of the pack 1200 through the pack outlet 1204.

As shown, the bottom film 1205 extends beyond the pack outlet 1205 to seal the entire bottom of an inverted top cup member 1206. In some applications, this configuration is advantageous as it reduces the number of parts, limits the amount of materials required, and reduces the assembly effort in constructing the pack 1200. The pack 1200 may be made up of only the top cup member 1206 (e.g., formed using a single injection molding or stamping step) sealed with the bottom film 1205 and the top film 1204.

FIG. 5C shows a view of the bottom of the flavor pack 1200 with the film 1205 removed for illustrative purposes only. Arrows indicate the flow path of water through the interior of the pack.

The interior of the pack 1200 includes flavor content 1209 which mixes with the inflowing water to produce a flavored beverage. Flavor may take a number of forms including liquid (e.g., a syrup), soluble or insoluble solids (e.g., powders, tea leaves, coffee grounds, etc.). Flavored beverages include cold beverages (e.g., flavored soda, fruit flavored drinks, etc.) or hot beverages (e.g., coffee, tea, hot cocoa). In some embodiments, prior to being unsealed, the interior of the pack 1200 may be evacuated or filled with an inert gas or other substance, e.g., to maintain freshness of the flavor content 1209.

Water flows in through the inlet 1202 and is directed from the central portion of the pack 1200 towards the periphery of the pack 1200, mixing with the flavor content. The mixed flavored beverage then exits the pack 1200 through the pack outlet 1204.

As shown, the cup member 1206 includes irrigation channels 1210 located around its peripheral edge (e.g., proximal the where the cup member seals with the bottom film 1205). The irrigation channels provide a more thorough and a homogeneous mixing and a more effective flavor extraction before flavored beverages are dispensed through the pack outlet 1204.

In some embodiments, the adaptor 1100 and/or the pack 1200 may include one or more filters. One or more of the inlets and outlets of the adaptor 1100 and/or the pack 1200 may include a valve, e.g., a check valve which allows only one way flow.

The adaptor 1100 and pack 1200 may be made of any suitable material. In some embodiments, one or more components of the devices are formed from or include a plastic (e.g., a thermoplastic) or polymer material (e.g., PFTE, PV, PU, nylon, etc.), a metal (e.g., copper, bronze, iron, steel, stainless steel, etc.), a composite, etc. The components may be fabricated using any suitable technique including, e.g., molding (e.g., injection molding), machining (e.g., using one or more computer numerical controlled “CNC” tools such as a mill or lathe), etc. The sealing films 1203 and 1205 on the flavor pack 1200 may be made of any suitable material, including a plastic, a foil, etc.

Some embodiments include a method of preparing a flavored beverage including attaching the flavor adaptor 1100 to a water dispenser, inserting the flavor pack 1200 into the flavor adaptor 1100, and closing the adaptor 1100, which may break one or more seals on the pack 1200. The method includes establishing a flow of water from the dispenser, through the inlet 1105 of the adaptor 1100, through the pack inlet 1202 into the interior of the flavor pack 1200 to mix with the flavor content 1209, and then out through the pack outlet 1204 and adaptor outlet 1110 to provide a flavored beverage.

In various embodiments any suitable water dispenser may be used including dispensers for chilled, unchilled (e.g., room temperature), and heated water. Some water dispensers dispense carbonated water. Water dispensers can include a reservoir or a pressurized source. Water dispensers may be stand alone devices, or incorporated into an appliance such as a refrigerator. In some embodiments, the dispenser may be of the type described in Provisional Patent Application No. 61/600,451 incorporated by reference above.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.), In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. An apparatus for dispensing water comprising:
a first inlet, a second inlet, and a third inlet;
a chamber in fluid communication with first, second and third inlets,
a dispenser nozzle in fluid communication with the chamber;
a chilled carbonated water source in fluid communication with the first inlet;
an unchilled water source in fluid communication with the second inlet; and
a heated water source in fluid communication with the third inlet.

2. The apparatus of claim 1, wherein the chamber is tapered with a wide end proximal the first, second, and third inlets and a narrow end proximal the nozzle.

3. The apparatus of claim 1, wherein the chamber operates as an expansion chamber for water flowing from any one of the inlets into the chamber.

4. The apparatus of claim 1, wherein at least one of the first, second, and third inlets includes a check valve configured to allow forward flow in a forward flow direction from the inlet to the chamber and to reduce or prevent back flow from the chamber in the opposite of the forward flow direction.

5. The apparatus of claim 1, wherein at least one of the first, second, and third inlets includes a check valve configured to allow forward flow in a forward flow direction from the inlet to the chamber and to reduce or prevent back flow from the chamber in the opposite of the forward flow direction.

6. That apparatus of claim 1, wherein the nozzle comprises a converging nozzle.

7. The apparatus of claim 1, wherein the nozzle comprises at least one connection facility for connecting a peripheral device.

8. The apparatus of claim 7, wherein the connection facility comprises a twist and lock connector.

9. The apparatus of claim 7, wherein the connection facility comprises at least one O-ring seal groove.

10. The apparatus of claim 1 further comprising a UV light source positioned to direct UV light onto water flowing into, through, or out of the apparatus.

11. The apparatus of claim 10, wherein the UV light source directs UV light onto water with a dosage of at least 1,000 microwatt seconds per square centimeter.

12. The apparatus of claim 10, wherein the UV light source directs UV light onto water with a dosage of at least 10,000 microwatt seconds per square centimeter.

13. The apparatus of claim 10, wherein the UV light source directs UV light onto water with a dosage of at least 100,000 microwatt seconds per square centimeter.

14. The apparatus of claim 1, wherein the chamber is configured to:
receive a carbonated water flow through at least one of the inlet;
condition the flow to reduce a flow rate or spattering of the carbonated water flow; and
direct a conditioned flow out through the nozzle.

15. The apparatus of claim 14, wherein the conditioned flow directed out through the nozzle is more laminar than the carbonated water flow received through the inlet.

16-23. (canceled)

24. The system of claim 1, wherein the chilled carbonated water source is configured to selectively dispense carbonated and still water.

25. The system of claim 1, wherein the chilled carbonated water source comprises an in-line carbonator.
